(19) United States
(12) Patent Application Publication
(10) Pub. No.: US 2002/0114222 A1
(43) Pub. Date: Aug. 22, 2002

(54) Audible timepiece

(76) Inventor: Tod Warmack, Tallahassee, FL (US)

Correspondence Address: Carnes, Cona and Dixon, Innovation Park, 1673 West Paul Dirac Drive, Tallahassee, FL, 32310-3763, US

(21) Appl. No.: 09/792,212

(22) Filed: Feb. 22, 2001

(51) Int. Cl. G04C 21/00; G04C 23/00; G04B 23/02

(52) U.S. Cl. 368/73

(57) ABSTRACT

The present invention is an audible timepiece designed and configured to sound a message when desired. This audible timepiece includes a first embodiment wherein at least one pre-recorded, un-eraseable message can be played at a pre-determine time. A second embodiment provides for the user to record at least one desired message that can be played at the pre-determined time. In this embodiment, the recordable message can be recorded over when desired, so as to allow for a new message to be stored and used as preferred by the user. In still a further embodiment of present invention, the timepiece will include at least one pre-recorded, un-eraseable message and include the option of having at least one recordable messaged stored therein. In this embodiment, the user can select either the desired pre-recorded or recordable message to be played at a predetermine time.

### BACKGROUND OF THE INVENTION

1. Field of the Invention

The present invention relates generally to a timepiece and more particularly to a timepiece that enables the user to provide for an audible message sound to be activated for alerting the individual of a particular time or to allow the user to record a desired message to be heard by the user at a predetermine time. Optionally, a multiplicity of messages can be stored in the timepiece so as to offer the user the choice of recording their own message or utilizing the storable message or messages therein.

2. Description of the Prior Art

Audible timepieces are well known in the art, and virtually every household in the United States is equipped with some sort of audible timepiece. There exist many that are alarm clocks that are in combination with a radio. Thus, enabling the user the option of utilizing an alarm sound or the option of hearing a pre-selected radio station for alerting the user of a particular time.

Accordingly, it is not surprising that numerous timepieces have been developed to add to the appeal and enhance for the consumer. For example, in U.S. Pat. No. 5,511,046 issued to Vanderpal, there is disclosed a timepiece that allows for the user to record a voice or other audible signal wherein the voice is played back at the preset alarm time. The unique feature in this product is the use of a microprocessor that controls all the functions of the alarm set and the use of triggering the alarm as well as the control of the input and output of the digitized audio signals.

Other devices have been developed to provide for an aesthetically pleasing and novel timepiece. For example in U.S. Pat. No. 4,730,284 issued to Adams, there is disclosed an alarm clock having the shape and structure of a particular animal, such as a rooster. The sound amplified from the clock, such as when the alarm is set for a particular time, will correspond to the animal that is depicted on the timepiece structure.

These patents as described above, have proven to be successful in providing unique timepieces with unique outcomes. What would be beneficial and enhance timepieces is to provide one that substantially reduces the amount and number of components generally associated with recordable and audible device, so as to inherently reduce the complexity and possibility of component failure. In addition, it would be advantageous to provide for timepiece with the option of selecting the desired message to be played backed at the desired time.

As will be seen, these previous efforts provide the benefits intended with the present invention as identified by the needs above. Additionally, prior techniques do not suggest the present inventive combination of component elements as disclosed and claimed herein. The present invention achieves its intended purposes, objectives and advantages over the prior art device through a new, useful and unobvious combination of component elements, which is simple to use, with the utilization of a minimum number of functioning parts, at a reasonable cost to manufacture, assemble, test and by employing only readily available material.

### SUMMARY OF THE INVENTION

The present invention is an audible timepiece designed and configured to sound a message when desired. This audible timepiece includes a first embodiment wherein at least one pre-recorded, un-eraseable message can be played at a pre-determine time. A second embodiment provides for the user to record at least one desired message that can be played at the pre-determined time. In this embodiment, the recordable message can be recorded over when desired, so as to allow for a new message to be stored and used as preferred by the user. In still a further embodiment of present invention, the timepiece will include at least one pre-recorded, un-eraseable message and include the option of having at least one recordable messaged stored therein. In this embodiment, the user can select either the desired pre-recorded or recordable message to be played at a predetermine time.

To enable such a configuration, the present invention comprises a housing having an interior area for storage of electrical components and an exterior area, including a display screen (LCD), and accessibility means for controlling the electrical components housed in the exterior area. The housing can further include an area for enabling a logo or the like to be located thereon.

The electrical components utilized in the present invention include conventional digital sound chips that are secured to a printed circuit board and are coupled to the various accessibility means for controlling and programming the alarm clock of the present invention. Thus, rendering a timepiece that allows the user to adjust the time, adjust the time of the alarm, record a message, select the desired message (audible alarm) to be heard, activate and/or deactivate the alarm, and enable the user to re-activate the alarm at different time intervals.

Accordingly, it is the object of the present invention to provide an audible alarm timepiece that will overcome the deficiencies, shortcomings, and drawbacks of the prior timepieces and methods thereof.

Another object of the present invention is to provide for a time piece having an unique audible alarm means, that when used as an alarm clock will encourage the user to wake at the particular pre-set time, by providing an entertaining audible sound.

Still another object of the present invention is to provide for an alarm timepiece, that includes the option of using a pre-recorded message or optionally, enabling the user to record a desired message.

Yet another object of the present invention is to provide for alarm timepiece that is simple in design and easy to utilize, so as to provide for a timepiece that can adequately and efficiently be utilized.

A final object of the present invention, to be specifically enumerated herein, is to provide an audible alarm timepiece in accordance with the preceding objects and that will conform to conventional forms of manufacture, be of simple construction and easy to use so as to provide a device that would be economically feasible, long lasting and relatively trouble free in operation.

Although there have been many timepiece devices, in particular a few are directed towards recordable messages, none of the timepieces have become sufficiently compact, low cost, and reliable enough to become commonly used. The present invention meets the requirements of the simplified design, compact size, low initial cost, low operating cost, ease of installation and maintainability, and minimal amount of training to successfully employ the invention.

The foregoing has outlined some of the more pertinent objects of the invention. These objects should be construed to be merely illustrative of some of the more prominent features and application of the intended invention. Many other beneficial results can be obtained by applying the disclosed invention in a different manner or modifying the invention within the scope of the disclosure. Accordingly, a fuller understanding of the invention may be had by referring to the detailed description of the preferred embodiments in addition to the scope of the invention defined by the claims taken in conjunction with the accompanying drawings.

### BRIEF DESCRIPTION OF THE DRAWING

FIG. 1 is a front planar view of the audible timepiece of present invention.

FIG. 2 is a block diagram of the elements used in the first embodiment of the audible timepiece of the present invention.

FIG. 3 is a block diagram of the elements used in the second embodiment of the audible timepiece of the present invention.

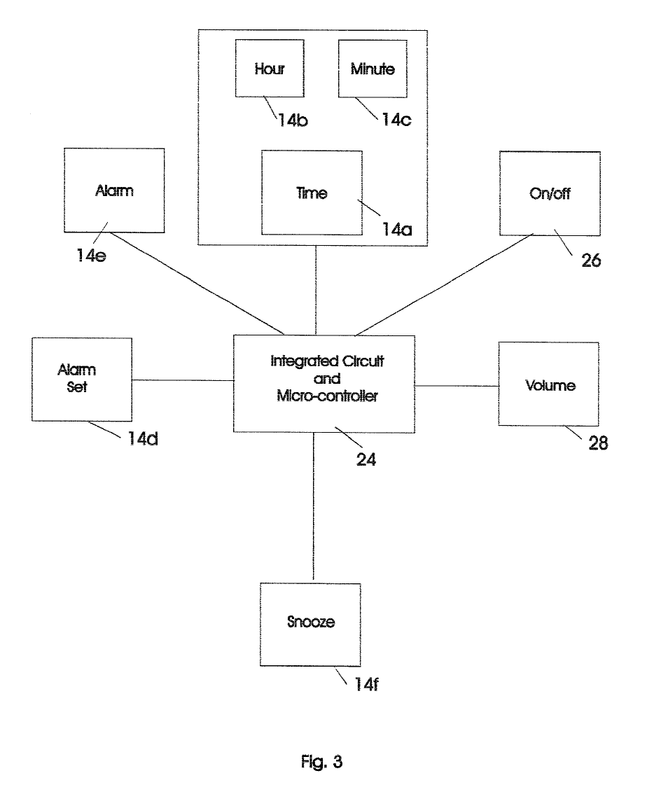

Similar reference numerals refer to similar parts throughout the several views of the drawings.

### DESCRIPTION OF THE PREFERRED EMBODIMENT

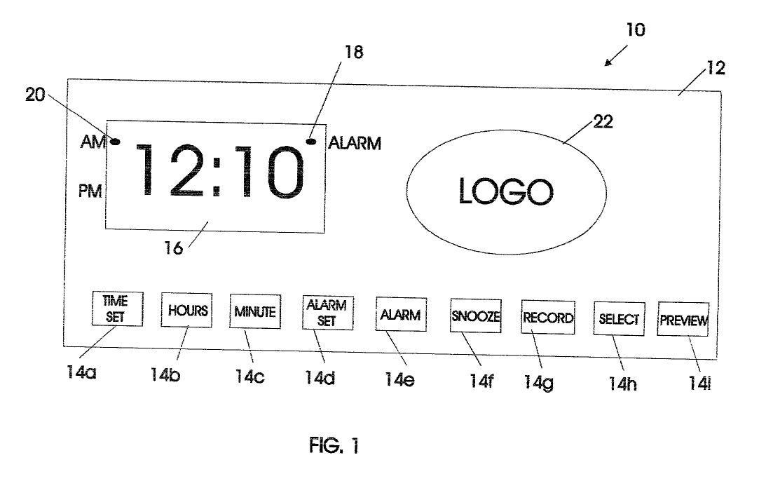

With reference to the drawings and in particular to FIG. 1, there is shown the audible time piece generally denoted by reference numeral 10, of the present invention. The audible timepiece of the present invention is designed and configured to allow the user to play an audible message for an alarm. Dependent on the embodiment, the messages can be recordable; pre-recorded and non-erasable; or a combination thereof.

Thus, in the recordable configuration, the user can record any desired message, such as a child reciting “Daddy, it's time to wake up.” This recorded message can be played as desired. Alternatively in the embodiment including a pre-recorded messaged, such as a well-known sport celebrity stating, “Come on champion, time to start the day”, can be stored therein. This pre-recorded message cannot be erased and can be selected as the sound heard when the alarm is set. In the preferred embodiment, there will be at least two pre-recorded messages that will randomly play, followed by a pre-recorded song, such as a fighting song of a particular collegiate team. In this preferred embodiment, the pre-recorded message will be broadcasting casting a game, followed by the fight sound of the particular collegiate school.

Enabling such user-friendly configuration, the audible timepiece 10, as seen in FIG. 1, includes housing 12 having an interior area and an exterior area. The interior area will house and protect all the electrical components of the present invention. Located exteriorly on the timepiece 10 are control devices 14. These control devices 14 are used to program and control the timepiece of the present invention. The time piece mechanism and control devices are generally conventional and well known in the art. The housing can have any shape and/or configuration and their purpose is to display the time and protect the electrical components utilized in the audible timepiece of the present invention.

As seen in FIG. 1, a display screen 16 is exteriorly located. This display screen 16 is conventional and preferably is a liquid crystal display (LCD). The purpose of the display 16 is to visually illustrate the time and to clearly enable the user to adjust the present time and/or alarm time when desired. In addition, the screen will further show the status of the alarm (activated or not activated) as well as illustrated which audible means is to be utilized at the pre-determine time (alarm time).

Generally if the alarm is activated or set for a predetermine time, a light source 18 (such as the use of a light emitting diode) will be activated. This light source if activated will verify that the alarm will sound at the pre-determine time. In addition, a light source 20, such as the use of a light emitting diode may be used to indicate if it is morning (AM) or afternoon (PM).

The control devices are used to program the present invention. As such, the control devices will include a time set 14a. This time set 14a will allow for the user to correctly and accurately set time on the timepiece. Separate hours 14b and minute control 14c devices can be provided. In addition, an alarm set 14d will be provided for rendering a means of assigning a time to active the audible sound. An alarm activation/deactivate device 14e can be provided for activation the alarm and deactivating the alarm. If the activation button is selected, then the audible message will sound at the time set for the alarm. If the deactivation button is selected, then the audible message will not sound at the time set. This deactivate device can also be utilized for terminating play of the message during play. Optionally, an oscillating device 14f can be provided for deactivating the alarm, yet enabling the alarm to re-sound after an extended pre-determine period of time. This oscillating device is communally known as a snooze. Dependent on the embodiment utilized, a record button 14g can be located thereon for enabling a user to record their desired message. Optionally, a select button 14h can also be located thereon for enabling the user to select which audible sound he wishes to hear when the alarm is activated. To preview the recorded message, a preview button 14i is located on the housing.

The exterior of the unit can further include an area 22 that can easily and adequately display a logo or the like. This will add to the aesthetic appeal of the audible timepiece of the present invention.

It is noted that the buttons can be at any location on the housing. The location should be easily accessible to the user. An example, which has proven to be successful is an alarm wherein the snooze button 14f, was located on the top of the housing and a volume control was located on the rear of the housing. This has proven to be successful and useful.

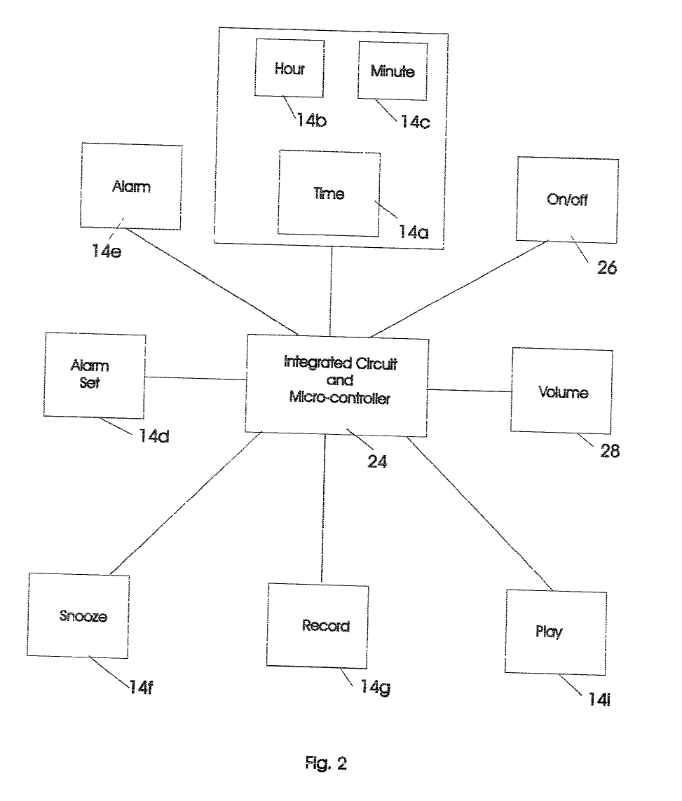

As seen in FIG. 2, the block diagram for the first embodiment of the present invention, the timepiece will permit the user to record at least one desired message. This message can be replayed at any time, so as to allow for the user to listen to the message when desired. In addition, this message can be recorded over when desired.

To allow for such a configuration, the present invention comprises a micro-controller 24. The micro-controller includes at least one conventional digital sound chip. The sound chips are conventional and will be secured to a printed circuit board (PCB). This circuit board is pre-programmed. Thereby providing for the chip to function when activated by the pre-programmed PCB. The program is to be written so that both the pre-recorded sound chip and the recordable sound chip are split into two equal time segments. For example, the pre-recorded chip will be splint into two ten second time segments. Each time segment within the sound chips will be selected by the alarm sound button. After the selection other sound chip will be activated by the pre-set alarm time. The sound will need to be programmed so that each time segment will cycle. Thus, once the ten-second-time segment has finished the program will return it to the beginning. This cycle will be infinite.

The sound chips for the recordable chips are high quality digital memory chips. These chips are conventional and will have the capability of having a message recorded on to them and holding that message for an infinite time period. This chip will also have the capability of being re-recorded with new messages for an infinite amount of times.

Thus, the micro-controller will control the conventional components of the alarm clock and in combination with the sound chips will provide a unique outcome for the audible alarm clock. The buttons that are located on the housing are switches that enable it to be in an open or closed position. In the open position, the circuit is open and therefore providing for an inoperative state. When closed, or activated, the system is in an operative state. Therefore, with the utilization of the buttons, the user can set the can set the time 14a by setting the hour 14b and minutes 14c time. The alarm time can also be set using the alarm set button 14d. For enabling activation of the alarm, the alarm button 14e is utilized. In the preferred embodiment, the time button 14a must be depressed simultaneously with the hour or minute buttons. In addition, the user can select for a temporally termination of the audible sound, known as the snooze 14f. The user can record a message 14g and can be play the desired message via the preview 14i. In addition, the user can select the desired message to be played (recorded message vs. non-recorded message) via the select mode 14h.

It is noted that in the preferred embodiment, the pre-recorded, non-erasable message is unique in that it includes at least two random messages. A common message or song follows these random messages. One random message will be selected and the common message will be played when the alarm is activated. The use of the dual messages provides for a final product that is unique, entertaining as well as providing an efficient means in alarming its user of the time. If the alarm is used to alert the user that it is time to wake up, then the alarm of the present invention has proven to work and in fact will encourage the user to wake and start their day.

The present invention will further include a power source (on/off) 26, that will allow for the system to work. The power source can be any conventional power means, such as, but not limited to, the user of outlet, batteries or the like. In addition, the user can alter the volume or pitch of the audible sounds from the alarm. This alteration is done conventionally via the volume control 28.

In the second embodiment, the recorder portion will be eliminated, thus providing for a simpler design. In this configuration only at least two prerecorded random messages are provided followed by a common message or song. This second embodiment will operate in the same manner and function as defined above and thus includes the micro-controller 24. Thus the simple will include means to set the time 14a, 14b, and 14c. An alarm set 14d and alarm time 14e will be coupled to the micro-controller 24. A snooze 14f and volume control is provided as well as a power source 26.

In the preferred embodiment a messages will be randomly played followed by a common message. However, this second embodiment can further include a select, as discuss above, so as to enable the user to select which random message that is to be played. This random message is to be followed by a common message.

While the invention has been particularly shown and described with reference to an embodiment thereof, it will be understood by those skilled in the art that various changes in form and detail may be made without departing from the spirit and scope of the invention.

I claim:

1. A timepiece comprising:
a time mechanism for recording time;
an alarm setting mechanism for setting an alarm time;
at least two pre-recorded random messages;
a singular pre-recorded constant message;
a micro-controller is coupled to said time mechanism, said alarm setting mechanism, said two pre-recorded random messages and said singular pre-recorded constant message; and
said micro-controller will provide for one of said at least two pre-recorded random messages to active and be followed by said singular pre-recorded constant message at a time set via said alarm setting mechanism.

2. A timepiece as in claim 1 wherein said micro-controller includes a mechanism for recording a desired message and providing a recorded message, a select mode is provide for enabling a user to select either said recorded message to be played or to provide for one of said at least two pre-recorded random messages to active and be followed by said singular pre-recorded constant message at a time set via said alarm setting mechanism.

3. A timepiece as in claim 1 wherein a conventional digital sound chip stores said at least two pre-recorded random message and said pre-recorded constant message.

4. A timepiece as in claim 1 wherein a housing having an interior and an exterior, said interior houses electrical components of said timepiece, said exterior includes a logo located thereon.

5. A timepiece as in claim 4 wherein said exterior further includes a liquid crystal display for displaying time and alarm time as set via said time mechanism and said alarm setting mechanism.

6. A timepiece comprising:
a time mechanism for recording time;
an alarm setting mechanism for setting an alarm time;
a recorder device having a sound chip;
a recorder mechanism for recording a message to said recorder device and said recorder device is coupled to said recorder mechanism;
a micro-controller is coupled to said time mechanism, said alarm setting mechanism, and said recorder device; and
said micro-controller will provide for a recorded message set and saved via said recorder device to be played at a time set via said alarm setting mechanism.

7. A timepiece as in claim 6 wherein a pre-recorded uneraseable message is stored on a second sound chip, said second sound chip is coupled to said micro-controller, a select mechanism is located on said timepiece for enabling a user to select said recorded message or said pre-recorded uneraseable message to be played at said time set via said alarm setting mechanism.

8. A timepiece as in claim 6 wherein at least two pre-recorded uneraseable messages are stored on a second sound chip, said second sound chip is coupled to said micro-controller, a select mechanism is located on said timepiece for enabling a usr to select said recorded message or said pre-recorded uneraseable messages to be played at said time set via said alarm setting mechanism.

9. A timepiece as in claim 6 wherein at least two pre-recorded random messages and a singular pre-recorded constant message are stored on subsequent sound chips, said subsequent sound chips are coupled to said micro-controller, a select mechanism is located on said timepiece for enabling a usr to select said recorded message or said pre-recorded uneraseable messages to be played at said time set via said alarm setting mechanism, and selecting said pre-recorded uneraseable messages will provide for said micro-controller to activated one of said at least two pre-recorded random messages and be followed by said singular pre-recorded constant message at a time set via said alarm setting mechanism.

10. A timepiece as in claim 6 wherein a housing having an interior and an exterior, said interior houses electrical components of said timepiece, said exterior includes a logo located thereon.

11. A timepiece comprising:
a time mechanism for recording time;
an alarm setting mechanism for setting an alarm time;
at least one pre-recorded random messages;
a singular pre-recorded constant message; a micro-controller is coupled to said time mechanism, said alarm setting mechanism, said two pre-recorded random messages and said singular pre-recorded constant message; and said micro-controller will provide for one of said at least two pre-recorded random messages to active and be followed by said singular pre-recorded constant message at a time set via said alarm setting mechanism.

12. A timepiece as in claim 11 wherein said micro-controller includes a mechanism for recording a desired message and providing a recorded message, a select mode is provided for enabling a user to select either said recorded message to be played or to provide for one of said at least two pre-recorded random messages to active and be followed by said singular pre-recorded constant message at a time set via said alarm setting mechanism.
